(19) United States
(12) Patent Application Publication
(10) Pub. No.: US 2014/0049708 A1
(43) Pub. Date: Feb. 20, 2014

(54) GLASS SUBSTRATE FOR LIQUID CRYSTAL LENS

(71) Applicants: Takashi Murata, Shiga (JP); Takahiro Kawaguchi, Shiga (JP)

(72) Inventors: Takashi Murata, Shiga (JP); Takahiro Kawaguchi, Shiga (JP)

(21) Appl. No.: 14/113,681

(22) PCT Filed: Apr. 19, 2012
(86) PCT No.: PCT/JP2012/060594

§ 371 Date: Oct. 24, 2013

(30) Foreign Application Priority Data
Apr. 25, 2011 (JP) 2011-096695

(51) Int. Cl. G02B 27/22

(52) U.S. Cl. CPC G02B 27/2214
USPC 349/15; 349/200

(57) ABSTRACT

Provided is a glass substrate for a liquid crystal lens, comprising, as a glass composition in terms of mol %, 45 to 75% of SiO₂, 5 to 15% of Al₂O₃, 0 to 15% of B₂O₃, 0 to 15% of MgO, and 0 to 15% of CaO, and having a thickness of 400 μm or less.

### TECHNICAL FIELD

The present invention relates to a glass substrate for a liquid crystal lens, which is applicable to a viewing zone control part or the like in a 3D display.

### BACKGROUND ART

In recent years, a 3D display device that does not require wearing glasses has been launched in the market. A parallax barrier system and a system using lenses have been proposed as 3D display systems that do not require wearing glasses. The parallax barrier system is a system in which binocular parallax is created by covering pixels of a display with stripe-shaped barriers arranged at proper intervals. Recently, there have been marketed some types of devices having barriers made of liquid crystal, and devices capable of switching between 2D and 3D modes. However, in those types of devices, no small part of a screen needs to be covered with some kinds of barriers, and hence there arises a problem of a reduction in brightness of a display.

On the other hand, the system using lenses has a fundamental principle similar to that of the parallax barrier system and is a system in which binocular parallax is created by using plastic film lenses instead of the barriers. In this system, there is no obstacle in front of a screen, and hence the brightness of a display can be easily maintained. However, there is a problem in that the switching between 2D and 3D modes is impossible.

As a method of solving those problems, a system in which viewing zone control is performed by using a liquid crystal lens has been studied. This system is a system in which an electric field is applied to liquid crystal existing between two glass substrates having formed thereon a polarizing film and a conductive film, causing the orientation of the liquid crystal to change and providing such a role as a kind of lens thereto, to thereby enable stereoscopic vision. Further, this system is expected to be used as a viewing zone control mechanism for a next-generation 3D display, because there is no obstacle in front of pixels unlike the parallax barrier system and the switching between 2D and 3D modes is possible.

### SUMMARY OF INVENTION

### Technical Problem

However, the system in which viewing zone control is performed by using a liquid crystal lens has a problem in that, when the liquid crystal lens is arranged on pixels of a display device, the distance between the pixel part and the lens is long, resulting in a narrow viewing angle of the 3D display.

This problem is attributed to the fact that a glass substrate having a thickness of 0.5 to 0.7 mm is already present on the front surface side of the display part in an LCD or an OLED and the thickness of the glass substrates for the liquid crystal lens is further added thereto.

On the other hand, when a glass substrate for a liquid crystal lens with a smaller thickness is used, the above-mentioned problem can be improved. However, conventional glass substrates with a smaller thickness are liable to bend. The bending of the glass substrates causes a problem in that desired films (for example, films such as a transparent conductive film) cannot be formed on the surfaces of the glass substrates.

Thus, a technical object of the present invention is to provide a glass substrate that is resistant to bending even with a small thickness, thereby achieving a viewing zone control part in a 3D display, which has a shorter distance between a pixel part and a lens and has a proper transparent conductive film and the like.

### Solution to Problem

The inventors of the present invention have repeated various experiments and have consequently found that the technical object described above can be achieved by strictly controlling the glass composition and dimension of a glass substrate. Thus, the finding is proposed as the present invention. That is, a glass substrate for a liquid crystal lens of the present invention comprises, as a glass composition in terms of mol %, 45 to 75% of SiO₂, 5 to 15% of Al₂O₃, 0 to 15% of B₂O₃, 0 to 15% of MgO, and 0 to 15% of CaO, and has a thickness of 400 μm or less.

When the glass composition is controlled as described above, the devitrification resistance and the specific Young's modulus can be increased. When glass has high devitrification resistance, the glass is easily formed into a glass substrate having a thickness of 400 μm or less, and when glass has a large specific Young's modulus, even a glass substrate having a thickness of 400 μm or less is difficult to bend. Further, when the glass composition is controlled as described above, the density and the viscosity at high temperature can be reduced.

Further, when the thickness of a glass substrate is controlled to 400 μm or less as mentioned above, it is possible to broaden a viewing angle at which a 3D display can provide stereoscopic vision. Besides, the glass substrate can have flexibility, and hence the glass substrate can be wound like a roll to produce a glass roll. When a glass substrate is formed into a glass roll, the formation of a transparent conductive film and the attachment of a polarizing film can be performed continuously, and hence the production efficiency of a liquid crystal lens improves dramatically.

Second, it is preferred that the glass substrate for a liquid crystal lens of the present invention have a specific Young's modulus of 29 GPa/(g/cm³) or more. Herein, the “specific Young's modulus” is a value obtained by dividing the Young's modulus by a value of the density. The “Young's modulus” refers to a value obtained by measurement by a well-known resonance method or the like. The “density” can be measured by a well-known Archimedes method or the like.

Third, it is preferred that the glass substrate for a liquid crystal lens of the present invention have a strain point of 650° C. or more. Herein, the “strain point” refers to a value obtained by measurement based on ASTM C336.

Fourth, it is preferred that the glass substrate for a liquid crystal lens of the present invention have a density of 2.7 g/cm³ or less.

Fifth, it is preferred that the glass substrate for a liquid crystal lens of the present invention have a temperature at 10^{2.5} dPa·s of 1,650° C. or less. Herein, the “temperature at 10^{2.5} dPa·s” corresponds to a melting temperature and refers to a value obtained by measurement by a platinum sphere pull up method.

Sixth, it is preferred that the glass substrate for a liquid crystal lens of the present invention have a liquidus viscosity of 10^{4.0} dPa·s or more. Herein, the “liquidus viscosity” refers to a value obtained by measuring the viscosity of glass at a liquidus temperature by a platinum sphere pull up method. The “liquidus temperature” refers to a value obtained by measuring a temperature at which crystals of glass are deposited after glass powder that passed through a standard 30-mesh sieve (500 μm) and remained on a 50-mesh sieve (300 μm) is placed in a platinum boat and then the boat is kept for 24 hours in a gradient heating furnace.

Seventh, it is preferred that the glass substrate for a liquid crystal lens of the present invention have a thermal expansion coefficient at 30 to 380° C. of 30 to 50×10⁻⁷/° C. Herein, the “thermal expansion coefficient” refers to an average value in the temperature range of 30 to 380° C. calculated from the values obtainedbymeasurement with a dilatometer.

Eighth, it is preferred that the glass substrate for a liquid crystal lens of the present invention be formed by an overflow down-draw method. Herein, the “overflow down-draw method” is also called a fusion method and refers to a method involving causing molten glass to overflow from both sides of a heat-resistant, trough-shaped structure, and subjecting the overflowing molten glass to down-draw downward while joining the flows of the overflowing molten glass at the lower end of the trough-shaped structure, to thereby form a glass substrate.

Ninth, a glass substrate for a liquid crystal lens of the present invention comprises, as a glass composition in terms of mol %, 45 to 75% of SiO₂, 5 to 15% of Al₂O₃, 0 to 15% of B₂O₃, 0 to 15% of MgO, and 0 to 15% of CaO, has a molar ratio MgO/CaO of 0 to 1.5, a molar ratio (SrO+BaO)/(MgO+CaO) of 0 to 1, a molar ratio MgO/Al₂O₃ of 0 to 1, a molar ratio CaO/Al₂O₃ of 0 to 3, and a molar ratio B₂O₃/SiO₂ of 0 to 0.3, is substantially free of an alkali metal oxide (Li₂O, Na₂O, or K₂O), As₂O₃, Sb₂O₃, PbO, and Bi₂O₃, and has a specific Young's modulus of 29 GPa/(g/cm³) or more, a thermal expansion coefficient at 30 to 380° C. of 30 to 50×10⁻⁷/° C., a density of 2.6 g/cm³ or less, a liquidus viscosity of 10^{5.0} dPa·s or more, a width dimension of 500 mm or more, a length dimension of 500 mm or more, and a thickness of 400 μm or less. Herein, the term “SrO+BaO” refers to the total amount of SrO and BaO. The term “MgO+CaO” refers to the total amount of MgO and CaO. The phrase “substantially free of” refers to the case where the content of a component of interest in the glass composition is less than 0.1 mol %. For example, the phrase “substantially free of As₂O₃” refers to the case where the content of As₂O₃ in the glass composition is less than 0.1 mol %.

Tenth, a glass substrate for a liquid crystal lens of the present invention comprises, as a glass composition in terms of mol %, 45 to 75% of SiO₂, 5 to 15% of Al₂O₃, 0 to 15% of B₂O₃, 0 to 15% of MgO, and 0 to 15% of CaO, has a molar ratio MgO/CaO of 0 to 1.5, a molar ratio (SrO+BaO)/(MgO+CaO) of 0 to 1, a molar ratio MgO/Al₂O₃ of 0 to 1, a molar ratio CaO/Al₂O₃ of 0 to 3, and a molar ratio B₂O₃/SiO₂ of 0 to 0.3, is substantially free of an alkali metal oxide, As₂O₃, Sb₂O₃, PbO, and Bi₂O₃, and has a specific Young's modulus of 29 GPa/(g/cm³) or more, a thermal expansion coefficient at 30 to 380° C. of 30 to 50×10⁻⁷/° C., a density of 2.6 g/cm³ or less, a liquidus viscosity of 10^{5.0} dPa·s or more, and a thickness of 400 μm or less.

Eleventh, a liquid crystal lens of the present invention comprises any one of the above-mentioned glass substrates for a liquid crystal lens.

Twelfth, a glass substrate of the present invention has a thickness of 400 μm or less and a specific Young's modulus of 29 GPa/(g/cm³) or more. Note that the glass substrate of the present invention can be used particularly suitably for a liquid crystal lens, but may be applied to, for example, a substrate for an OLED display in addition to the use for a liquid crystal lens.

Thirteenth, it is preferred that the glass substrate of the present invention be used for a liquid crystal lens.

### Advantageous Effects of Invention

According to the present invention as described above, it is possible to provide the glass substrate that is resistant to bending even with a small thickness. Thus, the use of the glass substrate enables the manufacture of a viewing zone control part in a 3D display, which has a shorter distance between a pixel part and a lens and has a proper transparent conductive film and the like.

### DESCRIPTION OF EMBODIMENTS

A glass substrate for a liquid crystal lens according to an embodiment of the present invention comprises, as a glass composition in terms of mol %, 45 to 75% of SiO₂, 5 to 15% of Al₂O₃, 0 to 15% of B₂O₃, 0 to 15% of MgO, and 0 to 15% of CaO. The reasons why the content range of each component is restricted as described above are shown below.

The content of SiO₂ is 45 to 75%, preferably 50 to 73%, more preferably 55 to 72%, still more preferably 60 to 70%. When the content of SiO₂ is too small, it is difficult to produce low-density glass. On the other hand, when the content of SiO₂ is too large, the viscosity at high temperature becomes improperly higher, the meltability deteriorates, and defects such as a devitrified crystal (cristobalite) are easily produced in glass.

The content of Al₂O₃ is 5 to 15%. When the content of Al₂O₃ is too small, it is difficult to enhance the Young's modulus and the heat resistance, the viscosity at high temperature becomes improperly higher, and the meltability is liable to deteriorate. Thus, the lower limit range of Al₂O₃ is suitably 7% or more, 9% or more, 10% or more, 11% or more, particularly suitably 12% or more. On the other hand, when the content of Al₂O₃ is too large, the liquidus temperature becomes higher and the denitrification resistance is liable to deteriorate. Thus, the upper limit range of Al₂O₃ is suitably 14.5% or less, 14% or less, 13.5% or less, particularly suitably 13% or less.

B₂O₃ is a component that functions as a melting accelerate component, reduces the viscosity at high temperature, and enhances the meltability. The content of B₂O₃ is 0 to 15%. When the content of B₂O₃ is too large, a reduction in Young's modulus makes it difficult to increase the specific Young's modulus, and the heat resistance and the weather resistance are liable to deteriorate. Thus, the upper limit range of B₂O₃ is suitably 11% or less, 8% or less, 5% or less, 3% or less, 1% or less, particularly suitably 0.5% or less. Note that, when the content of B₂O₃ is small, the viscosity at high temperature increases, the bubble quality tends to lower, and the density tends to increase.

The content of MgO is 0 to 15%. MgO is a component as described below. That is, MgO is a component that lowers the viscosity at high temperature and enhances the meltability without lowering the strain point. Further, MgO is a component that has the largest effect of reducing the density among alkaline earth metal oxides. In addition, MgO is a component that has a large effect of enhancing the Young's modulus. However, when the content of MgO is too large, the liquidus temperature rises and the devitrification resistance is liable to deteriorate. Thus, the upper limit range of MgO is suitably 12% or less, 10% or less, particularly suitably 9% or less. The lower limit range of MgO is suitably 1% or more, 1.5% or more, 3% or more, 3.5% or more, 4% or more, 6% or more, particularly suitably 7.5% or more.

The content of CaO is 0 to 15%. CaO is a component that lowers the viscosity at high temperature and remarkably enhances the meltability without lowering the strain point. Further, when the content of CaO is relatively increased in the contents of alkaline earth metal oxides, it is easy to produce low-density glass. However, when the content of CaO is too large, the thermal expansion coefficient and the density improperly increase, and the glass composition loses its component balance, with the result that the devitrification resistance is liable to deteriorate. Thus, the upper limit range of CaO is suitably 13% or less, 12% or less, 11% or less, 10.5% or less, 9% or less, particularly suitably 8% or less. Further, the lower limit range of CaO is suitably 1% or more, 3% or more, 4% or more, 5% or more, particularly suitably 5.5% or more.

The following components, for example, may be added in addition to the components described above.

SrO is a component that lowers the viscosity at high temperature and enhances the meltability without lowering the strain point. When the content of SrO is larger, the density and the thermal expansion coefficient are likely to increase. Further, when the content of SrO is larger, the contents of CaO and MgO need to be relatively decreased in order to cause the thermal expansion coefficient of glass to be consistent with that of Si. Then, the decreases of the contents of CaO and MgO are liable to cause a situation in which the devitrification resistance deteriorates, the Young's modulus decreases, and the viscosity at high temperature rises. Thus, the content of SrO is preferably 0 to 10%, 0 to 5%, 0 to 3%, 0 to 1.8%, 0 to 1.4%, 0 to 1%, particularly preferably 0 to 0.5%.

BaO is a component that lowers the viscosity at high temperature, enhances the meltability, and enhances the devitrification resistance without lowering the strain point. When the content of BaO is larger, the density and the thermal expansion coefficient are likely to increase. Further, when the content of BaO is larger, the contents of CaO and MgO need to be relatively decreased in order to cause the thermal expansion coefficient of glass to be consistent with that of Si. As a result, a situation in which the devitrification resistance deteriorates, the Young's modulus decreases, and the viscosity at high temperature rises is liable to occur. Thus, the content of BaO is preferably 0 to 10%. The upper limit range of BaO is suitably 8% or less, 6% or less, 5% or less, particularly suitably 3% or less. Further, the lower limit range of BaO is suitably 0.5% or more, 1% or more, 1.5% or more, particularly suitably 2% or more.

The molar ratio MgO/CaO is preferably 0 to 1.5. As the value of the molar ratio is larger, the Young's modulus tends to increase and the viscosity at high temperature tends to decrease. However, when the value is too large, glass is liable to denitrify. Thus, the upper limit range of the molar ratio MgO/CaO is suitably 1.4 or less, and the lower limit range thereof is suitably 0.2 or more, 0.4 or more, 0.6 or more, 0.8 or more, particularly suitably 1 or more.

The molar ratio (SrO+BaO)/(MgO+CaO) is preferably 0 to 1. As the value of the molar ratio is larger, the devitrification resistance tends to improve. However, when the value is too large, the viscosity at high temperature, the density, and the thermal expansion coefficient may become too high or the specific Young's modulus may decrease. Thus, the upper limit range of the molar ratio (SrO+BaO)/(MgO+CaO) is suitably 0.8 or less, 0.6 or less, 0.5 or less, 0.45 or less, 0.4 or less, particularly suitably 0.35 or less. Further, the lower limit range of the molar ratio (SrO+BaO)/(MgO+CaO) is suitably 0.05 or more, 0.1 or more, 0.15 or more, 0.2 or more, 0.25 or more, particularly suitably 0.3 or more.

The molar ratio MgO/Al₂O₃ is preferably 0 to 1. As the value of the molar ratio is larger, the Young's modulus tends to increase and the viscosity at high temperature tends to decrease. However, when the value is too large, the denitrification resistance deteriorates, and the density and the thermal expansion coefficient become too high. Thus, the upper limit range of the molar ratio MgO/Al₂O₃ is suitably 0.9 or less, 0.8 or less, 0.75 or less, particularly suitably 0.7 or less. Further, the lower limit range of the molar ratio MgO/Al₂O₃ is suitably 0.2 or more, 0.3 or more, particularly suitably 0.5 or more.

The molar ratio CaO/Al₂O₃ is preferably 0 to 3. As the value of the molar ratio is larger, the Young's modulus tends to increase and the viscosity at high temperature tends to decrease. However, when the value is too large, the liquidus viscosity becomes excessively high, and the density and the thermal expansion coefficient become too high. Thus, the upper limit range of the molar ratio CaO/Al₂O₃ is suitably 2 or less, 1.5 or less, 1 or less, 0.8 or less, particularly suitably 0.6 or less, and the lower limit range thereof is suitably 0.1 or more, 0.2 or more, 0.3 or more, 0.4 or more, particularly suitably 0.5 or more.

The molar ratio B₂O₃/SiO₂ is preferably 0 to 0.3. As the value of the molar ratio is larger, the viscosity at high temperature tends to decrease, the meltability tends to improve, and the density and the liquidus temperature tend to decrease. However, when the value is too large, the strain point and the Young's modulus are liable to decrease. Thus, the upper limit range of the molar ratio B₂O₃/SiO₂ is suitably 0.25 or less, 0.2 or less, 0.15 or less, particularly suitably 0.1 or less.

MgO+CaO+SrO+BaO are components that lower the liquidus temperature and prevent a crystal inclusion from being easily generated in glass, and are components that enhance the meltability and formability. The content of MgO+CaO+SrO+BaO is preferably 0 to 25%, 3 to 20%, 5 to 19%, 10 to 19%, 12 to 19%, 12.5 to 19%, particularly preferably 14 to 19%. When the content of MgO+CaO+SrO+BaO is too small, MgO+CaO+SrO+BaO cannot fully exert their functions as a melting accelerate component, and as a result, the meltability is liable to decrease and the thermal expansion coefficient becomes too low, resulting in difficulty in causing the thermal expansion coefficient of glass to be consistent with that of Si. On the other hand, when the content of MgO+CaO+SrO+BaO is too large, the density increases, resulting in difficulty in producing low-density glass, and in addition, the specific Young's modulus is liable to decrease and the thermal expansion coefficient may improperly increase. Note that the term “MgO+CaO+SrO+BaO” refers to the total amount of MgO, CaO, SrO, and BaO.

A fining agent is a component that is used for enhancing the bubble quality. As₂O₃ or Sb₂O₃ has been conventionally used as the fining agent. However, As₂O₃ and Sb₂O₃ are environmental load substances and the use amount of these substances is desirably reduced from the environmental point of view. Thus, the use of SnO₂ as the fining agent enables the enhancement of the bubble quality while taking environmental demands into consideration. SnO₂ is a component that exerts a good fining action in a high-temperature region and is a component that lowers the viscosity at high temperature. The content of SnO₂ is preferably 0 to 1%, 0.001 to 1%, 0.01 to 0.5%, particularly preferably 0.05 to 0.3%. When the content of SnO₂ is too large, devitrified crystals of SnO₂ are liable to precipitate in glass. Note that, when the content of SnO₂ is less than 0.001%, the above-mentioned effects are hardly provided.

As₂O₃ and Sb₂O₃ also effectively act as the fining agent. In this embodiment, although it is not necessary to completely exclude those components, it is preferred that the content of each of those components be restricted to less than 0.1%, particularly less than 0.05% from the environmental point of view. Meanwhile, a halogen such as F or Cl has effects of lowering the melting temperature and of promoting an action of the fining agent. Thus, the addition of the halogen enables the life of a glass manufacturing furnace to be lengthened while the melting cost is reduced. However, when the contents of F and Cl are too large, a metal wire pattern to be formed on a glass substrate for a liquid crystal lens corrodes in some cases. Thus, each of the contents of F and Cl is preferably 1% or less, 0.5% or less, less than 0.1%, 0.05% or less, particularly preferably 0.01% or less.

CeO₂, SO₃, C, or metal powder (for example, Al or Si) may be added as the fining agent as long as the characteristics of glass are not impaired.

ZnO is a component that enhances the meltability. However, when the content of ZnO is too large, glass is liable to denitrify, the strain point is liable to decrease, and the density is liable to increase. Thus, the content of ZnO is preferably 0 to 10%, 0 to 5%, 0 to 3%, 0 to 0.5%, 0 to 0.3%, particularly preferably 0 to 0.1%.

ZrO₂ is a component that enhances the weather resistance. However, when the content of ZrO₂ is too large, the devitrification resistance is liable to deteriorate and the dielectric constant and the dielectric dissipation factor are liable to rise. Thus, the content of ZrO₂ is preferably 0 to 5%, 0 to 3%, 0 to 0.5%, particularly preferably 0.01 to 0.2%. Further, when priority is given to the improvement of the devitrification resistance, the content of ZrO₂ is preferably restricted to 0.01% or less.

TiO₂ is a component that lowers the viscosity at high temperature, enhances the meltability, and suppresses the solarization. However, when TiO₂ is added in a large amount to the glass composition, glass is colored and the transmittance is liable to decrease. Thus, the content of TiO₂ is preferably 0 to 5%, 0 to 3%, 0 to 1%, particularly preferably 0 to 0.02%.

P₂O₅ is a component that enhances the devitrification resistance. However, when P₂O₅ is added in a large amount to the glass composition, phase separation and opaline are liable to result in glass, and the water resistance may remarkably deteriorate. Thus, the content of P₂O₅ is preferably 0 to 5%, 0 to 1%, particularly preferably 0 to 0.5%.

Y₂O₃, Nb₂O₅, and La₂O₃ each have a function of increasing the strain point. However, when the contents of those components are too large, the density is liable to rise. Thus, each of the contents of Y₂O₂, Nb₂O₅, and La₂O₂ is preferably 0 to 3%, 0 to 1%, particularly preferably 0 to 0.1%.

When the content of an alkali metal oxide is larger, the thermal expansion coefficient increases, the strain point lowers, and the characteristics of a TFT degrade. Thus, the content of the alkali metal oxide is preferably 0 to 6%, 0 to 3%, 0 to 1%, particularly preferably 0 to 0.1%. Besides, it is desired that glass be substantially free of the alkali metal oxide.

From the environmental point of view, it is preferred that glass be substantially free of PbO and Bi₂O₂.

It is naturally possible to select any suitable content range of each component, thereby constructing suitable glass composition ranges. Among the suitable glass composition ranges, the following glass composition ranges are particularly preferred from the viewpoints of the denitrification resistance, density, specific Young's modulus, viscosity at high temperature, environmental demands, and the like.

(1) A glass composition comprising, in terms of mol %, 50 to 75% of SiO₂, 7 to 15% of Al₂O₂, 0 to 11% of B₂O₃, 0 to 10% of MgO, and 0 to 12% of CaO, having a molar ratio MgO/CaO of 0 to 1.5, a molar ratio (SrO+BaO)/(MgO+CaO) of 0 to 0.5, a molar ratio MgO/Al₂O₃ of 0 to 0.8, a molar ratio CaO/Al₂O₃ of 0 to 1.5, and a molar ratio B₂O₃/SiO₂ of 0 to 0.2, and being substantially free of an alkali metal oxide, As₂O₃, Sb₂O₃, PbO, and Bi₂O₃.

(2) A glass composition comprising, in terms of mol %, 55 to 73% of SiO₂, 9 to 15% of Al₂O₃, 0 to 8% of B₂O₃, 1.5 to 10% of MgO, and 3 to 10.5% of CaO, having a molar ratio MgO/CaO of 0.2 to 1.4, a molar ratio (SrO+BaO)/(MgO+CaO) of 0.1 to 0.5, a molar ratio MgO/Al₂O₃ of 0.2 to 0.8, a molar ratio CaO/Al₂O₃ of 0.2 to 1, and a molar ratio B₂O₃/SiO₂ of 0 to 0.2, and being substantially free of an alkali metal oxide, As₂O₃, Sb₂O₃, PbO, and Bi₂O₃.

(3) A glass composition comprising, in terms of mol %, 60 to 73% of SiO₂, 10 to 15% of Al₂O₃, 0 to 5% of B₂O₃, 2 to 10% of MgO, and 3 to 8% of CaO, having a molar ratio MgO/CaO of 0.6 to 1.4, a molar ratio (SrO+BaO)/(MgO+CaO) of 0.15 to 0.45, a molar ratio MgO/Al₂O₃ of 0.2 to 0.8, a molar ratio CaO/Al₂O₃ of 0.2 to 0.6, and a molar ratio B₂O₃/SiO₂ of 0 to 0.2, and being substantially free of an alkali metal oxide, As₂O₃, Sb₂O₃, PbO, and Bi₂O₃.

(4) A glass composition comprising, in terms of mol %, 60 to 73% of SiO₂, 11 to 15% of Al₂O₃, 0 to 3% of B₂O₃, 3 to 9% of MgO, and 3 to 8% of CaO, having a molar ratio MgO/CaO of 0.8 to 1.4, a molar ratio (SrO+BaO)/(MgO+CaO) of 0.15 to 0.4, a molar ratio MgO/Al₂O₃ of 0.3 to 0.75, a molar ratio CaO/Al₂O₃ of 0.3 to 0.6, and a molar ratio B₂O₃/SiO₂ of 0 to 0.15, and being substantially free of an alkali metal oxide, As₂O₃, Sb₂O₃, PbO, and Bi₂O₃.

(5) A glass composition comprising, in terms of mol %, 60 to 72% of SiO₂, 12 to 15% of Al₂O₃, 0 to 3% of B₂O₃, 6 to 9% of MgO, and 5 to 8% of CaO, having a molar ratio MgO/CaO of 1 to 1.4, a molar ratio (SrO+BaO)/(MgO+CaO) of 0.15 to 0.3, a molar ratio MgO/Al₂O₃ of 0.5 to 0.75, a molar ratio CaO/Al₂O₃ of 0.4 to 0.6, and a molar ratio B₂O₃/SiO₂ of 0 to 0.1, and being substantially free of an alkali metal oxide, As₂O₃, Sb₂O₃, PbO, and Bi₂O₃.

(6) A glass composition comprising, in terms of mol %, 60 to 72% of SiO₂, 12 to 15% of Al₂O₃, 0 to 3% of B₂O₃, 7.5 to 9% of MgO, and 5 to 8% of CaO, having a molar ratio MgO/CaO of 1 to 1.4, a molar ratio (SrO+BaO)/(MgO+CaO) of 0.15 to 0.3, a molar ratio MgO/Al₂O₃ of 0.5 to 0.7, a molar ratio CaO/Al₂O₃ of 0.4 to 0.6, and a molar ratio B₂O₃/SiO₂ of 0 to 0.1, and being substantially free of an alkali metal oxide, As₂O₃, Sb₂O₃, PbO, and Bi₂O₃.

The glass substrate for a liquid crystal lens according to this embodiment has a thickness of preferably 400 μm or less, 300 μm or less, 200 μm or less, particularly preferably 100 μm or less. As the thickness thereof is smaller, a viewing angle at which a 3D display can provide stereoscopic vision is broaden, and the glass substrate has a lighter weight, and hence a device having a lighter weight can be produced. Further, the flexibility of the glass substrate improves. Hence, flexibility is easily provided to a device and it is possible to manufacture a liquid crystal lens by a roll-to-roll process.

In the glass substrate for a liquid crystal lens according to this embodiment, the lower limit value of each of the length dimension and width dimension is preferably 500 mm or more, 700 mm or more, particularly preferably 1,000 mm or more. Further, the upper limit value of each of the length dimension and width dimension is preferably 3,000 mm or less, particularly preferably 2,500 mm or less. As the length dimension and width dimension are larger, a large-screen 3D display can be manufactured more easily. However, when the length dimension and width dimension are too large, the bending amount becomes too large, resulting in easy breakage of a glass substrate.

The glass substrate for a liquid crystal lens according to this embodiment has a surface roughness Ra of preferably 50 Å or less, 30 Å or less, 10 Å or less, 5 Å or less, 3 Å or less, particularly preferably 2 Å or less. When the surface roughness Ra is large, the quality of a film such as an ITO film to be formed on a glass substrate deteriorates, thereby possibly causing a display defect of a device. Herein, the “surface roughness Ra” refers to a value obtained by measurement by a method in accordance with JIS B0601: 2001.

The glass substrate for a liquid crystal lens according to this embodiment has a density of preferably 2.7 g/cm³ or less, 2.68 g/cm³ or less, 2.66 g/cm³ or less, 2.63 g/cm³ or less, 2.61 g/cm³ or less, 2.59 g/cm³ or less, 2.57 g/cm³ or less, particularly preferably 2.55 g/cm³ or less. When the density is large, it is difficult to produce light-weight glass.

The glass substrate for a liquid crystal lens according to this embodiment has a thermal expansion coefficient of preferably 30 to 50×10⁻⁷/° C., 32 to 50×10⁻⁷/° C., 35 to 50×10⁻⁷/° C., 37 to 50×10⁻⁷/° C., 38 to 49×10⁻⁷/° C., particularly preferably 38 to 46×10⁻⁷/° C. When the thermal expansion coefficient is beyond any of the above-mentioned ranges, the glass substrate is liable to have warpage owing to the difference in thermal expansion coefficient between the glass substrate and each of films such as a transparent conductive film and a patterning film. Besides, it is difficult to bond the glass substrate with a substrate on the display device side.

The glass substrate for a liquid crystal lens according to this embodiment has a strain point of preferably 650° C. or more, 670° C. or more, 690° C. or more, 700° C. or more, 715° C. or more, 720° C. or more, particularly preferably 730° C. or more. When the strain point is higher, the glass substrate has a smaller change in dimension even when, for example, patterning of a conductive film is performed on the glass substrate. Thus, high-precision patterning can be performed on both sides of the glass substrate.

The glass substrate for a liquid crystal lens according to this embodiment has a liquidus temperature of preferably 1,320° C. or less, 1,290° C. or less, 1,250° C. or less, 1,220° C. or less, 1,190° C. or less, particularly preferably 1,170° C. or less. With this, devitrified crystals are hardly produced in glass. Hence, a glass substrate having a thickness of 400 μm or less can be easily formed by an overflow down-draw method or the like. As a result, the manufacturing cost of the glass substrate can be reduced while the surface quality of the glass substrate is improved. Note that the liquidus temperature is an indicator of the devitrification resistance. As the liquidus temperature is lower, the devitrification resistance is more excellent.

The glass substrate for a liquid crystal lens according to this embodiment has a liquidus viscosity of preferably 10^{4.0} dPa·s or more, 10^{4.3} dPa·s or more, 10^{4.5} dPa·s or more, 10^{4.7} dPa·s or more, 10^{5.0} dPa·s or more, 10^{5.3} dPa·s or more, particularly preferably 10^{5.5} dPa·s or more. With this, devitrified crystals are hardly produced in glass during shape formation. Hence, a glass substrate having a thickness of 400 μm or less can be easily formed by an overflow down-draw method or the like. As a result, the manufacturing cost of the glass substrate for a liquid crystal lens can be reduced while the surface quality of the glass substrate for a liquid crystal lens is improved. Note that the liquidus viscosity is an indicator of the formability. As the liquidus viscosity is higher, the formability is more excellent.

High-temperature melting generally increases a burden on a glass melting furnace. As a refractory such as alumina and zirconia used in the glass melting furnace is exposed to a higher temperature, the refractory is eroded by molten glass more severely. As the amount of erosion of the refractory increases, the life cycle of the glass melting furnace is shortened, and hence the manufacturing cost of the glass substrate increases significantly. Further, when high-temperature melting is performed, it is necessary to use a constituent member with high heat resistance as a constituent member for the glass melting furnace, and hence the cost of the constituent member for the glass melting furnace becomes higher, resulting in a significant increase in melting cost. Moreover, the inside of the glass melting furnace needs to be maintained at high temperature to perform high-temperature melting, and hence the running cost is much higher compared with that of low-temperature melting. Thus, the temperature at 10^{2.5} dPa·s is preferably 1,650° C. or less, 1,640° C. or less, 1,620° C. or less, 1,600° C. or less, particularly preferably 1,580° C. or less. When the temperature at 10^{2.5} dPa·s is too high, the manufacturing cost of a glass substrate becomes significantly higher, and the bubble quality is liable to deteriorate.

The glass substrate for a liquid crystal lens according to this embodiment has a specific Young's modulus of preferably 29 GPa/(g/cm³) or more, 30 GPa/(g/cm³) or more, 30.5 GPa/(g/cm³) or more, 31 GPa/(g/cm³) or more, particularly preferably 31.5 GPa/(g/cm³) or more. As the specific Young's modulus is higher, a large thin glass substrate is more difficult to bend by virtue of its own weight.

It is possible to show a combination of an LCD and a liquid crystal lens and a combination of an OLED and a liquid crystal lens as examples of the configuration of a 3D display. In this case, it is preferred to adopt a process in which the respective devices are produced, followed by bonding them. With this, defective products of the respective devices can be preliminarily removed, and hence the manufacturing yield of a 3D display can be enhanced. On the other hand, with this, the thickness of an opposing substrate in an LCD or an OLED is added, and hence a 3D may have a narrower viewing angle. In order to avoid the case, it is preferred to perform patterning of a lens device on a surface of the glass substrate for a liquid crystal lens according to this embodiment and form a CF or the like subsequently on the back surface of the glass substrate, then using the resultant glass substrate as an opposing substrate in an LCD or an OLED. When such a structure as described above is adopted, the distance between a pixel part and a lens substantially corresponds to the thickness of the glass substrate for a liquid crystal lens, and hence a 3D display can have a larger viewing angle.

The glass substrate for a liquid crystal lens according to this embodiment can be produced by loading a glass batch prepared so as to have a predetermined glass composition, into a continuous glass melting furnace, heating and melting the glass batch, then fining the resultant molten glass, feeding the fined molten glass into a forming apparatus, and forming the fined molten glass into a thin sheet shape or the like.

The glass substrate for a liquid crystal lens according to this embodiment is preferably formed by an overflow down-draw method. With this, an unpolished glass substrate having good surface quality can be produced. This is because, when the glass substrate is formed by the overflow down-draw method, the surface that should serve as the surface of the glass substrate is formed in the state of a free surface without being brought into contact with a trough-shaped refractory. The structure and material of the forming trough are not particularly limited as long as a desired dimension and surface quality can be achieved. In addition, a method of applying a force to glass in conducting down-draw downward is not particularly limited as long as a desired dimension and surface quality can be achieved. For example, there may be adopted a method involving drawing glass by rotating a heat-resistant roll having a sufficiently large width while being brought into contact with the glass, or a method involving drawing glass by bringing a plurality of pairs of heat-resistant rolls into contact with only the vicinity of the edge surface of the glass in the width direction. Note that, as the liquidus temperature is lower or the liquidus viscosity is higher, a glass substrate having a thickness of 400 μm or less is formed more easily by an overflow down-draw method.

In addition to the overflow down-draw method, any of other forming methods may be adopted. For example, there may be adopted a slot down-draw method, a re-draw method, or a float method.

The glass substrate according to an embodiment of the present invention has a thickness of 400 μm or less and a specific Young's modulus of 29 GPa/(g/cm³) or more, and is preferably used for a liquid crystal lens. The technical features (suitable compositions, suitable characteristics, and effects) of the glass substrate according to this embodiment are identical to the technical features already described of the glass substrate for a liquid crystal lens according to this embodiment, and hence detailed descriptions thereof are omitted.

### EXAMPLES

### Example 1

Examples of the present invention are described below. Note that the following examples are merely for illustrative purposes. The present invention is by no means limited to the following examples.

Tables 1 to 5 show Examples of the present invention (Sample Nos. 1 to 35).

TABLE 1

| | | No. 1 | No. 2 | No. 3 | No. 4 | No. 5 | No. 6 | No. 7 |
|---|---|---|---|---|---|---|---|---|
| Glass | SiO₂ | 71.5 | 72.4 | 70.9 | 71.6 | 71.3 | 70.4 | 71.1 |
| composition | Al₂O₃ | 10.6 | 10.7 | 10.5 | 10.6 | 10.5 | 10.7 | 10.0 |
| (mol %) | B₂O₃ | — | — | — | — | — | 2.0 | 2.0 |
| | MgO | — | — | 3.3 | 3.4 | — | — | — |
| | CaO | 13.8 | 11.5 | 11.3 | 9.0 | 13.7 | 11.5 | 11.5 |
| | SrO | — | 1.3 | — | 1.3 | 1.3 | 1.3 | 1.3 |
| | BaO | 4.0 | 4.0 | 3.9 | 4.0 | 3.1 | 4.0 | 4.0 |
| | SnO₂ | 0.1 | 0.1 | 0.1 | 0.1 | 0.1 | 0.1 | 0.1 |

| | | | | | | | |
|---|---|---|---|---|---|---|---|
| MgO/CaO | 0 | 0 | 0.30 | 0.38 | 0 | 0 | 0 |
| (SrO + BaO)/(MgO + CaO) | 0.29 | 0.46 | 0.27 | 0.43 | 0.32 | 0.47 | 0.47 |
| MgO/Al₂O₃ | 0 | 0 | 0.32 | 0.32 | 0 | 0 | 0 |
| CaO/Al₂O₃ | 1.30 | 1.07 | 1.08 | 0.85 | 1.30 | 1.08 | 1.15 |
| B₂O₃/SiO₂ | 0 | 0 | 0 | 0 | 0 | 0.03 | 0.03 |
| ρ [g/cm³] | 2.64 | 2.65 | 2.64 | 2.64 | 2.63 | 2.64 | 2.63 |
| α [×10⁻⁷/° C.] | 45 | 45 | 44 | 43 | 46 | 45 | 45 |
| Ps [° C.] | 750 | 754 | 738 | 741 | 749 | 716 | 712 |
| Ta [° C.] | 804 | 809 | 793 | 798 | 802 | 772 | 768 |
| Ts [° C.] | 1,027 | 1,039 | 1,020 | 1,032 | 1,023 | 1,002 | 1,000 |
| 10⁴ dPa · s [° C.] | 1,348 | 1,367 | 1,340 | 1,363 | 1,335 | 1,327 | 1,329 |
| 10³ dPa · s [° C.] | 1,519 | 1,541 | 1,508 | 1,533 | 1,503 | 1,498 | 1,503 |
| 10^{2.5} dPa · s [° C.] | 1,628 | 1,653 | 1,614 | 1,640 | 1,610 | 1,607 | 1,615 |
| TL [° C.] | 1,212 | 1,215 | 1,217 | 1,221 | 1,215 | 1,170 | 1,187 |
| log₁₀η [dPa · s] | 5.2 | 5.3 | 5.1 | 5.2 | 5.0 | 5.4 | 5.2 |
| Young's modulus | Not | 82 | Not | 80 | 81 | 79 | 78 |
| [GPa] | measured | | measured | | | | |
| Specific Young's | Not | 31.0 | Not | 30.4 | 30.9 | 30.0 | 29.8 |
| modulus | measured | | measured | | | | |
| [GPa/(g/cm³)] | | | | | | | |
| Rigidity modulus | Not | 34 | Not | 33 | 34 | 33 | 33 |
| [GPa] | measured | | measured | | | | |
| Surface roughness Ra | Not | Not | Not | Not | Not | 0.2 | Not |
| [nm] | measured | measured | measured | measured | measured | | measured |

TABLE 2

| | | No. 8 | No. 9 | No. 10 | No. 11 | No. 12 | No. 13 | No. 14 |
|---|---|---|---|---|---|---|---|---|
| Glass | SiO₂ | 69.8 | 72.0 | 70.6 | 71.0 | 70.9 | 71.4 | 70.5 |
| composition | Al₂O₃ | 11.1 | 10.7 | 10.8 | 10.9 | 10.8 | 10.9 | 11.1 |
| (mol %) | B₂O₃ | 2.0 | 2.0 | 2.0 | 2.0 | 2.0 | 2.0 | 2.0 |
| | CaO | 11.6 | 10.4 | 10.4 | 9.2 | 10.4 | 9.2 | 10.9 |
| | SrO | 1.3 | 1.2 | 2.0 | 2.7 | 1.3 | 1.4 | 1.3 |
| | BaO | 4.1 | 3.6 | 4.1 | 4.1 | 4.5 | 5.0 | 4.1 |
| | SnO₂ | 0.1 | 0.1 | 0.1 | 0.1 | 0.1 | 0.1 | 0.1 |

| | | | | | | | |
|---|---|---|---|---|---|---|---|
| MgO/CaO | 0 | 0 | 0 | 0 | 0 | 0 | 0 |
| (SrO + BaO)/(MgO + CaO) | 0.47 | 0.46 | 0.58 | 0.74 | 0.56 | 0.69 | 0.49 |
| MgO/Al₂O₃ | 0 | 0 | 0 | 0 | 0 | 0 | 0 |
| CaO/Al₂O₃ | 1.04 | 0.97 | 0.96 | 0.85 | 0.96 | 0.85 | 0.99 |
| B₂O₃/SiO₂ | 0.03 | 0.03 | 0.03 | 0.03 | 0.03 | 0.03 | 0.03 |
| ρ [g/cm³] | 2.64 | 2.60 | 2.64 | 2.65 | 2.64 | 2.65 | 2.63 |
| α [×10⁻⁷/° C.] | 45 | 43 | 44 | 44 | 44 | 44 | 44 |
| Ps [° C.] | 718 | 726 | 716 | 719 | 717 | 720 | 720 |
| Ta [° C.] | 774 | 784 | 773 | 777 | 775 | 779 | 777 |
| Ts [° C.] | 1,003 | 1,026 | 1,008 | 1,016 | 1,011 | 1,020 | 1,011 |
| 10⁴ dPa · s [° C.] | 1,326 | 1,362 | 1,338 | 1,347 | 1,345 | 1,360 | 1,342 |
| 10³ dPa · s [° C.] | 1,496 | 1,538 | 1,512 | 1,522 | 1,520 | 1,536 | 1,515 |
| 10^{2.5} dPa · s [° C.] | 1,604 | 1,648 | 1,621 | 1,633 | 1,628 | 1,648 | 1,623 |
| TL [° C.] | 1,186 | 1,229 | 1,170 | 1,179 | 1,158 | 1,159 | 1,190 |
| log₁₀η [dPa · s] | 5.2 | 5.1 | 5.5 | 5.5 | 5.6 | 5.8 | 5.3 |

TABLE 3

| | | No. 15 | No. 16 | No. 17 | No. 18 | No. 19 | No. 20 | No. 21 |
|---|---|---|---|---|---|---|---|---|
| Glass | SiO₂ | 70.2 | 70.6 | 71.0 | 71.1 | 71.2 | 71.0 | 70.6 |
| composition | Al₂O₃ | 11.1 | 11.5 | 10.8 | 10.9 | 10.8 | 10.8 | 10.8 |
| (mol %) | B₂O₃ | 2.0 | 2.0 | 1.4 | 1.4 | 1.4 | 1.4 | 1.4 |
| | MgO | — | — | — | — | — | — | 0.9 |
| | CaO | 11.3 | 10.4 | 10.4 | 9.8 | 10.4 | 10.4 | 10.4 |
| | SrO | 1.3 | 1.3 | 1.3 | 1.7 | 1.3 | 1.3 | 1.0 |
| | BaO | 4.0 | 4.1 | 4.5 | 4.5 | 4.5 | 4.5 | 4.5 |
| | ZnO | — | — | 0.5 | 0.5 | — | 0.3 | — |
| | P₂O₅ | — | — | — | — | 0.3 | 0.2 | 0.3 |
| | SnO₂ | 0.1 | 0.1 | 0.1 | 0.1 | 0.1 | 0.1 | 0.1 |

| | | | | | | | |
|---|---|---|---|---|---|---|---|
| MgO/CaO | 0 | 0 | 0 | 0 | 0 | 0 | 0.08 |
| (SrO + BaO)/(MgO + CaO) | 0.46 | 0.52 | 0.56 | 0.63 | 0.56 | 0.56 | 0.49 |
| MgO/Al₂O₃ | 0 | 0 | 0 | 0 | 0 | 0 | 0.08 |
| CaO/Al₂O₃ | 1.02 | 0.9 | 0.96 | 0.9 | 0.96 | 0.96 | 0.96 |
| B₂O₃/SiO₂ | 0.03 | 0.03 | 0.02 | 0.02 | 0.02 | 0.02 | 0.02 |
| ρ [g/cm³] | 2.63 | 2.63 | 2.66 | 2.66 | 2.65 | 2.65 | 2.64 |
| α [×10⁻⁷/° C.] | 45 | 43 | 45 | 44 | 44 | 45 | 44 |
| Ps [° C.] | 720 | 728 | 721 | 722 | 728 | 724 | 723 |
| Ta [° C.] | 777 | 785 | 778 | 780 | 786 | 782 | 780 |
| Ts [° C.] | 1,009 | 1,024 | 1,013 | 1,017 | 1,022 | 1,018 | 1,015 |
| 10⁴ dPa · s [° C.] | 1,338 | 1,353 | 1,342 | 1,350 | 1,355 | 1,352 | 1,344 |
| 10³ dPa · s [° C.] | 1,509 | 1,524 | 1,516 | 1,524 | 1,529 | 1,526 | 1,518 |
| 10^{2.5} dPa · s [° C.] | 1,617 | 1,632 | 1,630 | 1,636 | 1,640 | 1,636 | 1,633 |
| TL [° C.] | 1,196 | 1,215 | 1,184 | 1,183 | 1,175 | 1,177 | 1,177 |
| log₁₀η [dPa · s] | 5.2 | 5.2 | 5.4 | 5.4 | 5.6 | 5.5 | 5.5 |
| Young's modulus | Not | Not | Not | Not | 79 | Not | 79 |
| [GPa] | measured | measured | measured | measured | | measured | |
| Specific Young's | Not | Not | Not | Not | 29.8 | Not | 30.1 |
| modulus | measured | measured | measured | measured | | measured | |
| [GPa/(g/cm³)] | | | | | | | |
| Rigidity modulus | Not | Not | Not | Not | 33 | Not | 30 |
| [GPa] | measured | measured | measured | measured | | measured | |

TABLE 4

| | | No. 22 | No. 23 | No. 24 | No. 25 | No. 26 | No. 27 | No. 28 |
|---|---|---|---|---|---|---|---|---|
| Glass | SiO₂ | 70.7 | 70.3 | 69.9 | 70.2 | 70.1 | 69.6 | 69.5 |
| composition | Al₂O₃ | 10.9 | 11.2 | 11.6 | 12.4 | 11.2 | 11.1 | 11.1 |
| (mol %) | B₂O₃ | 1.4 | 1.4 | 1.4 | 4.1 | 1.4 | 1.4 | 1.4 |
| | MgO | — | — | — | 4.1 | 1.7 | 1.7 | 1.7 |
| | CaO | 10.4 | 10.5 | 10.5 | 6.0 | 9.2 | 10.4 | 10.3 |
| | SrO | 1.4 | 1.4 | 1.4 | 1.3 | 1.3 | 0.7 | 1.3 |
| | BaO | 4.6 | 4.6 | 4.6 | 1.9 | 4.5 | 4.5 | 4.1 |
| | P₂O₅ | 0.5 | 0.5 | 0.5 | — | 0.5 | 0.5 | 0.5 |
| | SnO₂ | 0.1 | 0.1 | 0.1 | 0.1 | 0.1 | 0.1 | 0.1 |

| | | | | | | | |
|---|---|---|---|---|---|---|---|
| MgO/CaO | 0 | 0 | 0 | 0.68 | 0.19 | 0.17 | 0.17 |
| (SrO + BaO)/(MgO + CaO) | 0.57 | 0.56 | 0.56 | 0.32 | 0.54 | 0.43 | 0.45 |
| MgO/Al₂O₃ | 0 | 0 | 0 | 0.33 | 0.15 | 0.15 | 0.15 |
| CaO/Al₂O₃ | 0.96 | 0.93 | 0.90 | 0.48 | 0.82 | 0.93 | 0.93 |
| B₂O₃/SiO₂ | 0.02 | 0.02 | 0.02 | 0.06 | 0.02 | 0.02 | 0.02 |
| ρ [g/cm³] | 2.65 | 2.65 | 2.65 | Not | Not | Not | Not |
| | | | | measured | measured | measured | measured |
| α [×10⁻⁷/° C.] | 45 | 45 | 44 | Not | 43 | 44 | 44 |
| | | | | measured | | | |
| Ps [° C.] | 728 | 731 | 733 | Not | 722 | 720 | 720 |
| | | | | measured | | | |
| Ta [° C.] | 786 | 788 | 790 | Not | 780 | 777 | 777 |
| | | | | measured | | | |
| Ts [° C.] | 1,022 | 1,023 | 1,024 | Not | 1,017 | 1,011 | 1,009 |
| | | | | measured | | | |
| 10⁴ dPa · s [° C.] | 1,352 | 1,352 | 1,350 | Not | 1,344 | 1,335 | 1,330 |
| | | | | measured | | | |
| 10³ dPa · s [° C.] | 1,525 | 1,523 | 1,519 | Not | 1,516 | 1,504 | 1,498 |
| | | | | measured | | | |
| 10^{2.5} dPa · s [° C.] | 1,637 | 1,633 | 1,627 | Not | 1,624 | 1,611 | 1,605 |
| | | | | measured | | | |
| TL [° C.] | 1,176 | 1,182 | 1,190 | Not | 1,179 | 1,182 | 1,191 |
| | | | | measured | | | |
| log₁₀η [dPa · s] | 5.6 | 5.5 | 5.4 | Not | 5.5 | 5.4 | 5.2 |
| | | | | measured | | | |
| Young's modulus | Not | 79 | Not | Not | 79 | Not | Not |
| [GPa] | measured | | measured | measured | | measured | measured |
| Specific Young's | Not | 29.7 | Not | Not | Not | Not | Not |
| modulus | measured | | measured | measured | measured | measured | measured |
| [GPa/(g/cm³)] | | | | | | | |
| Rigidity modulus | Not | 33 | Not | Not | 33 | Not | Not |
| [GPa] | measured | | measured | measured | | measured | measured |

TABLE 5

| | No. 29 | No. 30 | No. 31 | No. 32 | No. 33 | No. 34 | No. 35 |
|---|---|---|---|---|---|---|---|
| SiO₂ | 68.7 | 70.0 | 70.5 | 70.4 | 67.2 | 67.3 | 67.5 |
| Al₂O₃ | 11.2 | 11.2 | 11.1 | 11.0 | 12.3 | 12.2 | 12.3 |
| B₂O₃ | 1.4 | 1.4 | 1.4 | 1.4 | 2.8 | 2.8 | 2.8 |
| MgO | 5.4 | 0.9 | 2.6 | 3.4 | 8.2 | 7.9 | 7.9 |
| CaO | 8.1 | 10.4 | 8.6 | 8.5 | 6.3 | 6.2 | 6.2 |
| SrO | 1.1 | 1.0 | 0.7 | 0.3 | 0.6 | 1.3 | 0.6 |
| BaO | 3.5 | 4.5 | 4.5 | 4.0 | 2.2 | 2.2 | 2.6 |
| ZnO | — | — | — | 0.4 | — | — | — |
| P₂O₅ | 0.5 | 0.5 | 0.5 | 0.5 | 0.3 | — | — |
| SnO₂ | 0.1 | 0.1 | 0.1 | 0.1 | 0.1 | 0.1 | 0.1 |
| MgO/CaO | 0.66 | 0.08 | 0.30 | 0.40 | 1.31 | 1.28 | 1.28 |
| (SrO + BaO)/(MgO + CaO) | 0.34 | 0.49 | 0.46 | 0.36 | 0.19 | 0.24 | 0.23 |
| MgO/Al₂O₃ | 0.48 | 0.08 | 0.23 | 0.31 | 0.67 | 0.65 | 0.65 |
| CaO/Al₂O₃ | 0.73 | 0.93 | 0.78 | 0.78 | 0.51 | 0.50 | 0.50 |
| B₂O₃/SiO₂ | 0.02 | 0.02 | 0.02 | 0.02 | 0.04 | 0.04 | 0.04 |
| ρ [g/cm³] | Not | Not | Not | Not | 2.56 | 2.57 | 2.57 |
| | measured | measured | measured | measured | | | |
| α [×10⁻⁷/° C.] | 41 | Not | Not | Not | 38 | 39 | 38 |
| | | measured | measured | measured | | | |
| Ps [° C.] | 718 | 725 | 725 | 722 | 718 | 718 | 719 |
| Ta [° C.] | 774 | 782 | 784 | 780 | 774 | 774 | 774 |
| Ts [° C.] | 1,006 | 1,016 | 1,024 | 1,022 | 998 | 998 | 1,000 |
| 10⁴ dPa · s [° C.] | 1,321 | 1,341 | 1,358 | 1,350 | 1,301 | 1,298 | 1,303 |
| 10³ dPa · s [° C.] | 1,484 | 1,509 | 1,530 | 1,520 | 1,458 | 1,454 | 1,460 |
| 10^{2.5} dPa · s [° C.] | 1,589 | 1,618 | 1,637 | 1,628 | 1,555 | 1,555 | 1,561 |
| TL [° C.] | 1,190 | 1,182 | 1,187 | 1,206 | 1,219 | 1,181 | 1,182 |
| log₁₀η [dPa · s] | 5.2 | 5.4 | 5.5 | 5.2 | 4.7 | 5.1 | 5.1 |
| Young's modulus | Not | 80 | 80 | 80 | 83 | 83 | 84 |
| [GPa] | measured | | | | | | |
| Specific Young's | Not | Not | Not | Not | 32.5 | 32.5 | 32.5 |
| modulus | measured | measured | measured | measured | | | |
| [GPa/(g/cm³)] | | | | | | | |
| Rigidity modulus | Not | 33 | 33 | 33 | 34 | 34 | 34 |
| [GPa] | measured | | | | | | |
| Surface roughness Ra | Not | Not | Not | Not | Not | 0.2 | Not |
| [nm] | measured | measured | measured | measured | measured | | measured |

Sample Nos. 1 to 35 were produced in the following manner. First, glass batches were blended so that each of the glass compositions in the tables was attained, the glass batches were loaded into a platinum crucible and were melt at 1,600° C. for 24 hours, and then the resultant molten glass was caused to flow on a carbon plate to be formed into a plate shape. Next, each of the resultant samples was evaluated for its density ρ, thermal expansion coefficient α, strain point Ps, annealing temperature Ta, softening temperature Ts, temperature at 10⁴ dPa·s, temperature at 10³ dPa·s, temperature at 10^{2.5} dPa·s, liquidus temperature TL, liquidus viscosity log₁₀ηTL, Young's modulus, specific Young's modulus, and rigidity modulus.

The density ρ refers to a value obtained by measurement by a well-known Archimedes' method.

The thermal expansion coefficient α refers to an average value in the temperature range of 30 to 380° C. calculated from the values obtained by measurement with a dilatometer.

The strain point Ps, the annealing temperature Ta, and the softening temperature Ts are values obtained by measurement based on ASTM C336.

The temperature at 10^{4.0} dPa·s, the temperature at 10^{3.0} dPa·s, and the temperature at 10^{2.5} dPa·s are values obtained by measurement by a platinum sphere pull up method.

The liquidus temperature TL refers to a value obtained by measuring a temperature at which crystals of glass are deposited after glass powder that passed through a standard 30-mesh sieve (500 μm) and remained on a 50-mesh sieve (300 μm) is placed in a platinum boat and then the platinum boat is kept for 24 hours in a gradient heating furnace.

The liquidus viscosity log₁₀ηTL refers to a value obtainedbymeasuring the viscosity of glass at a liquidus temperature TL by a platinum sphere pull up method.

The Young's modulus and the rigidity modulus refer to values obtained by measurement by a well-known resonance method.

As evident from Tables 1 to 5, each of Sample Nos. 1 to 35 had a glass composition controlled in a predetermined range, and hence had a density ρ of 2.66 g/cm³ or less, a thermal expansion coefficient a of 38 to 46×10⁻⁷/° C., a strain point Ps of 712° C. or more, a temperature at 10^{2.5} dPa·s of 1,653° C. or less, a liquidus temperature TL of 1,229° C. or less, a liquidus viscosity log₁₀ηTL of 4.7 or more, a Young's modulus of 78 GPa or more, and a specific Young's modulus of 29.7 GPa/(g/cm³) or more. In particular, each of Sample Nos. 1 to 35 has good denitrification resistance, and hence is easily formed into a glass substrate having a thickness of 400 μm or less. Besides, each of Sample Nos. 1 to 35 has a large specific Young's modulus, and hence the resultant glass substrate is difficult to bend even when the glass substrate has a thickness of 400 μm or less. Thus, each of Sample Nos. 1 to 35 is considered to be suitable for a glass substrate for a liquid crystal lens. Note that each of Sample Nos. 1 to 35 did not comprise As₂O₃ and Sb₂O₃ in its glass composition but comprised SnO₂, and hence had good bubble quality.

### Example 2

Each of the glass batches corresponding to Sample Nos. 6 and 34 was melted in a test melting furnace, and then formed into a glass substrate for a liquid crystal lens having a width of 1,500 mm and a thickness of 250 μm by an overflow down-draw method. As a result, the glass substrate for a liquid crystal lens was found to have a surface roughness Ra of 20 Å or less (see Tables 1 and 5). Note that, when the formation was performed, the surface quality of the glass substrate for a liquid crystal lens was controlled by appropriately adjusting the speed of a drawing roller, the speed of a cooling roller, the temperature distribution in a heating apparatus, the temperature of molten glass, the flow rate of molten glass, a glass sheet-drawing speed, the rotation number of a stirrer, and the like.

1-13. (canceled)

14. A viewing zone control member, comprising:
two glass substrates facing each other; and
liquid crystal existing between the glass substrates;
wherein each of the glass substrates has a thickness of 400 μm or less and a specific Young's modulus of 29 GPa/(g/cm³) or more.

15. The viewing zone control member according to claim 14, wherein switching between 2D and 3D modes is possible.

16. The viewing zone control member according to claim 14, wherein each of the glass substrates has, as a glass composition in terms of mol %, 45 to 75% of SiO₂, 5 to 15% of Al₂O₃, 0 to 15% of B₂O₃, 0 to 15% of MgO, and 0 to 15% of CaO.

17. The viewing zone control member according to claim 14, wherein each of the glass substrates has a strain point of 650° C. or more.

18. The viewing zone control member according to claim 14, wherein each of the glass substrates has a density of 2.7 g/cm³ or less.

19. The viewing zone control member according to claim 14, wherein each of the glass substrates has a temperature at 10^{2.5} dPa·s of 1,650° C. or less.

20. The viewing zone control member according to claim 14, wherein each of the glass substrates has a liquidus viscosity of 10^{4.0} dPa·s or more.

21. The viewing zone control member according to claim 14, wherein each of the glass substrates has a thermal expansion coefficient at 30 to 380° C. of 30 to 50×10⁻⁷/° C.

22. The viewing zone control member according to claim 14, wherein each of the glass substrates is formed by an overflow down-draw method.

23. The viewing zone control member according to claim 14, wherein each of the glass substrates has, as a glass composition in terms of mol %, 45 to 75% of SiO₂, 5 to 15% of Al₂O₃, 0 to 15% of B₂O₃, 0 to 15% of MgO, and 0 to 15% of CaO, having a molar ratio MgO/CaO of 0 to 1.5, a molar ratio (SrO+BaO)/(MgO+CaO) of 0 to 1, a molar ratio MgO/Al₂O₃ of 0 to 1, a molar ratio CaO/Al₂O₃ of 0 to 3, and a molar ratio B₂O₃/SiO₂ of 0 to 0.3, being substantially free of an alkali metal oxide, As₂O₃, Sb₂O₃, PbO, and Bi₂O₃, and a specific Young's modulus of 29 GPa/(g/cm³) or more, a thermal expansion coefficient at 30 to 380° C. of 30 to 50×10⁻⁷/° C., a density of 2.6 g/cm³ or less, a liquidus viscosity of 10^{5.0} dPa·s or more, and a thickness of 400 μm or less.

24. The viewing zone control member according to claim 23, wherein each of the glass substrates has a width dimension of 500 mm or more, and a length dimension of 500 mm or more.

25. The viewing zone control member according to claim 14, wherein the viewing zone control member is used for a liquid crystal lens.

26. The viewing zone control member according to claim 15, wherein the viewing zone control member is used for a liquid crystal lens.

27. The viewing zone control member according to claim 16, wherein the viewing zone control member is used for a liquid crystal lens.

28. The viewing zone control member according to claim 17, wherein the viewing zone control member is used for a liquid crystal lens.

29. The viewing zone control member according to claim 18, wherein the viewing zone control member is used for a liquid crystal lens.

30. The viewing zone control member according to claim 19, wherein the viewing zone control member is used for a liquid crystal lens.

31. The viewing zone control member according to claim 20, wherein the viewing zone control member is used for a liquid crystal lens.

32. The viewing zone control member according to claim 21, wherein the viewing zone control member is used for a liquid crystal lens.

33. The viewing zone control member according to claim 22, wherein the viewing zone control member is used for a liquid crystal lens.
